(19) United States
(12) Patent Application Publication
(10) Pub. No.: US 2025/0296300 A1
(43) Pub. Date: Sep. 25, 2025

(54) COMPOSITE MATERIAL AND METHOD FOR MANUFACTURING SAME

(71) Applicant: UNILIN, BV, Wielsbeke (BE)

(72) Inventor: Benjamin CLEMENT, Waregem (BE)

(21) Appl. No.: 18/868,832

(22) PCT Filed: May 22, 2023
(86) PCT No.: PCT/IB2023/055238

§ 371 Date: Nov. 25, 2024

(30) Foreign Application Priority Data
Jun. 8, 2022 (EP) 22177728.7

(51) Int. Cl. B32B 25/06; B32B 3/30; B32B 7/12; B32B 29/00; B32B 29/02

(52) U.S. Cl. CPC B32B 25/06; B32B 3/30; B32B 7/12; B32B 29/005; B32B 29/02; B32B 2255/12; B32B 2255/26; B32B 2255/28; B32B 2260/028; B32B 2260/046; B32B 2307/402; B32B 2307/412; B32B 2307/718; B32B 2307/7376; B32B 2451/00; B32B 2471/04

(57) ABSTRACT

A composite material and a method for manufacturing same such that the composite material includes a laminate structure and a substrate. The substrate is a flexible substrate. The laminate structure has an upper surface and a lower surface. The laminate structure includes at least one paper and a resin, for example at least one resin impregnated paper. The laminate structure is bonded to the substrate. The laminate structure includes a plurality of slots extending from the upper surface of the laminate structure towards the substrate to thereby impart flexibility on the composite material.

The present invention relates to a composite material comprising a substrate—preferably a flexible substrate—, and a method of manufacturing a composite material. The present invention also pertains to a decorative panel comprising a composite material.

Laminates comprising resin-impregnated layers of paper, such as high-pressure laminates (HPL) or continuous pressed laminates (CPL), are frequently used for applications in which abrasion, impact and stain resistance are desired. Such applications include work surfaces, such as counter and tabletops, as well as flooring. A significant advantage of laminates over real wood for such applications is that the laminate can include a décor paper layer which can be printed with essentially any image, such that these are not limited to wood designs and/or specific colours. Also, uniform colours are possible. Not only does this mean that virtually any wood type, stone type, pattern, colour etc. can be chosen, it also allows any image to be repeated

Since the resin used in laminates such as HPL is typically a thermosetting resin, for example a melamine-formaldehyde based resin, the resulting laminate structure is rigid. This limits the fields of use of such laminate structures to objects having essentially planar surfaces. Such laminates also feel hard, and they contribute little to sound dampening.

Although it is known to process real wood, particularly in the form of a wood veneer, to make it more flexible (see for example EP 2 776 240), the resulting material has an appearance which is dictated by the type of wood. Since veneers are made of natural material, the colour and texture may vary somewhat per production. These natural variations limit the design possibilities and reproduction of a certain texture/pattern, and replacement of a damaged element with a new one. Durability of the veneer is linked to the type of wood, soft wood gives low impact resistance and unprotected veneer edges will absorb water. Also veneers are little chemically resistant.

It is therefore an object of the present invention to provide a composite material that is an alternative to known composite materials and which may offer advantages over existing composite materials.

The above object, and others, is solved in accordance with the present invention by the provision of a composite material comprising a laminate structure and a substrate. The substrate preferably is a flexible substrate. The laminate structure has an upper surface and a lower surface and comprises at least one paper and a resin, for example at least one resin impregnated paper. The laminate structure is bonded to the substrate. The laminate structure includes a plurality of slots extending from the upper surface of the laminate structure towards the substrate. Said laminate structure can for example comprise two or more resin impregnated papers.

The provision of a paper and a resin in the laminate structure provides freedom in the choice of decorative effect that can be attained, as well as enabling advantages normally associated, for example, with a high-pressure laminate. Preferably at least one thermoset resin is present. For example the laminate structure can only comprise one or more thermoset resins. It is also possible that one or more thermoplastic resins are present. The desired abrasion, impact and stain resistance can be obtained. The decorative effect can for example be a wood look, a stone look, a unicolour, colour with shades, etc. By providing the laminate structure with a plurality of slots, flexibility can be imparted to an otherwise essentially rigid structure. Further said plurality of slots contributes to the look of the composite material. Said composite material can contribute to sound dampening. This laminate structure is fully resonated and absorbs very little water. Further said laminate structure has a good chemical resistance and/or good colour fastness. This laminate structure can for example be a HPL or CPL.

The substrate preferably is a flexible substrate. More preferably, the flexible substrate is a substrate which when a 100 mm by 100 mm rectangular sample of it is draped over a sphere having a diameter of 100 mm bends at least in two planes perpendicular to each other. It is a benefit of such flexible substrate that they show drapability.

The substrate can have a certain design and/or certain (surface) colour and/or certain print, depending on the desired aesthetics. Said substrate can have certain perforations/a grid structure/etc. to provide the composite material with the desired acoustic properties.

In an embodiment the laminate structure has a laminate structure thickness and, preferably, at least 50%, more preferably at least 70% and most preferably all, of the slots of the plurality of slots have a depth corresponding to at least 70% of the laminate structure thickness, preferably at least 90% of the laminate structure thickness, more preferably at least 99% of the laminate structure thickness, most preferably 100% of the laminate structure thickness. The depth of the plurality of slots is one parameter that determines the flexibility of the composite material, with the greater the depth, the higher the flexibility. Said plurality of slots will contribute to the flexibility of the laminate structure. Said plurality of slots may or may not be at least partially filled up with another material, that is different from the laminate structure. It should be clear that, in addition to said plurality of slots, said composite material and/or said laminate structure at the height of its upper surface, can also have a surface texture, for example embossments, which are not regarded as said plurality of slots. The plurality of slots forms a total slot surface at the upper surface of the laminate structure. With at least 50% or at least 70% of the slots of the plurality of slots, is indicated that for at least 50% or at least 70% of said total slot surface, said corresponding slots have a maximum depth as described above.

The laminate structure may comprise a décor layer in the form of a printed and/or coloured paper layer impregnated with a first resin, and at least one additional layer. The at least one additional layer may be an overlay on an upper surface of the décor layer and/or a core layer on a lower surface of the décor layer. One, two, three or more overlays can be present. One, two, three, four, five, or more core layers can be present. Since the décor layer is in the form of a printed and/or coloured paper layer, any image and/or colour may be chosen. The overlay offers protection for the printed image and a core layer will assist in stabilizing the décor layer. The strength and/or resistance to abrasion can be enhanced by having two or more of the above-mentioned additional layers. With an overlay can be indicated a paper layer impregnated with for example a melamine urea formaldehyde resin, a melamine formaldehyde resin, a polyurethane resin or an acrylic resin, and this for example for extra abrasion resistance. Additionally a said overlay can comprise anti-abrasive particles, such as corundum or aluminum oxide particles, for superior abrasion resistance. With a core layer can be indicated a kraft paper impregnated with a melamine urea formaldehyde resin, a melamine urea phenol formaldehyde resin, a melamine formaldehyde resin, a phenol formaldehyde resin or a polyurethane resin. Off course said overlay and core layer are not limited to the above-mentioned examples.

The laminate structure could also comprise an unimpregnated décor layer or another unimpregnated paper layer. Said laminate structure can be manufactured by a so-called dry press. Said unimpregnated décor layer could be a paper layer. This décor layer could be sandwiched between two resin impregnated paper layers, for example between two overlays or between an overlay and a core layer. In this embodiment, no impregnation is needed for the décor layer, which could be useful if the décor layer is digitally printed. Since less thermoset resin can be used for this embodiment, this can improve the flexibility of the laminate structure even more.

By varying the number of paper layers constituting the laminate structure and the amount of resin, the laminate structure thickness may be between 0.2 and 4.0 mm, preferably between 0.4 and 2.5 mm.

In one embodiment, the laminate structure is bonded to the substrate by means of an adhesive layer. This offers the advantage that the laminate structure can be produced in a dedicated press and thereafter bonded to a substrate of choice. This adhesive layer can comprise a thermoset, such as an aminoplast polymer produced for example by a polycondensation reaction with urea and formaldehyde, such as urea formaldehyde (UF), melamine urea formaldehyde (MUF), melamine formaldehyde (MF), phenol formaldehyde (PF) or melamine urea phenol formaldehyde (MUPF). The adhesive layer can for example comprise a bio-based glue, such as a glue based upon lignin and/or starch and/or sugar. The adhesive layer can comprise a PMDI based glue (polymeric methylene difenyl di-isocyanate), a polyurethane based glue, a polyvinylbutyral based glue, a polyacrylate based glue (PA based glue), a PUR hotmelt (polyurethane hotmelt) etc.

Further said adhesive layer can or cannot comprise a sheet, such as a paper. For example, the adhesive layer can be a resin impregnated paper. The adhesive layer could also comprise other types of glue or a mixture of different types of glue.

In an alternative embodiment, the laminated structure can be directly bonded to the substrate. With directly bonded is indicated that no intermediate layer, such as an intermediate adhesive layer, is used to connect the laminate structure to the substrate. The laminate structure comprises at least one paper and a resin. This resin can then contribute to, or completely take care of, bonding the laminated structure to the substrate. For example, the laminate structure can comprise multiple layers of resin impregnated papers, wherein the bottom layer then takes care of the bonding between the laminated structure and the substrate. Said resin of the bottom layer can for example be a thermoset resin, for example a resin comprising melamine. An advantage of this embodiment is that the composite material can be produced in a one stage process, for example during one pressing operation. For example, a stack is formed comprising a layer being the substrate and also comprising one or more layers, that will form the laminated structure, and this stack is pressed, resulting in a laminated structure attached to the substrate. During this pressing all the layers of the stack become attached to each other and the laminated structure, as well as the entire composite material, is formed.

In an embodiment, the plurality of slots forms a pattern, preferably a pattern comprising intersecting slots, such as a grid structure made up of intersecting rows of said plurality of slots. Depending on the desired effect, the plurality of slots may be rectilinear. Said pattern will influence the flexibility and the look of the composite material.

Another parameter which influences the flexibility of the composite material is the width of the plurality of slots. Thus, in an embodiment, the plurality of slots has a slot width at the upper surface of the laminate structure, the slot width being at least 5% of the laminate structure thickness, preferably at least 10%, more preferably at least 20%, most preferably at least 30%. Some slots may have a slot width of at least 50%, preferably at least 70%, more preferably at least 90% of the laminate structure thickness. It is even possible that some slots have a slot width of more than 100%, for example more than 120% of the laminate structure thickness. Since the composite material is a flexible material, the slot width is measured when the composite material is placed flat upon a flat horizontal surface, for example with the substrate placed parallel upon the flat surface.

To impart a desirable visual effect, the plurality of slots may be at least partially filled with a lacquer. The lacquer may be PU-based, acrylic-based or latex, and it may be transparent or coloured. The lacquer is preferably a resilient material, such that the lacquer allows flexibility of the composite material. This lacquer can also give the composite material the desired strength and/or flexibility and/or ensure that dirt is not able to enter the slots. The lacquer can be waterbased. The lacquer can be (energy) curable.

The lacquer may comprise additives preferably selected from the group consisting of anti-abrasive particles such as corundum, matting agents, easy-cleaning additives, and anti-slip additives.

The lacquer can have one, two or more layers. The different layers can have a different type/composition of lacquer and/or can comprise different additives. For example, only the upper layer can comprise additives, such that less additives are needed.

In one embodiment, the additional layer in the laminate structure is an overlay and the lacquer fills the plurality of slots up to the overlay such that the overlay is exposed. In such an embodiment, the glossiness of the overlay can be different to that of the lacquer, thereby imparting an attractive appearance to the composite material. The upper surface of the composite material is here formed by the lacquer and by the laminate structure and can or cannot be textured. This is possible because the lacquer can be textured and/or the upper surface of the laminate structure can be textured. To provide the upper surface of the composite material with a texture, said texture can be provided after the lacquer is applied in the slots, for example with the aid of a pressure element and/or chemical embossing and/or a laser treatment and/or from the lacquer curing procedure (for example soft touch feeling). The texture can also be provided before or during the application of the lacquer in the slots.

In another embodiment, the lacquer can completely fill the plurality of slots to form an upper surface of the composite material. With such an embodiment, a substantially single gloss appearance can be attained. The upper surface can have the same characteristics over its entire surface. Said upper surface can or cannot be textured. To provide the upper surface of the composite material with a texture, said texture can be provided after the lacquer is applied in the slots, for example with the aid of a pressure element and/or chemical embossing and/or a laser treatment and/or from the lacquer curing procedure (for example soft touch feeling). The texture can also be provided during the application of the lacquer in the slots.

The substrate is selected depending on the intended use of the composite material. The substrate can be selected from the group consisting of woven or nonwoven webs, textile cloths, foamed sheets (preferably a flexible foamed sheet), resilient films such as extruded films and/or thermoplastic films, elastomers, rubbers, and even cellulose, such as thin flexible cellulose, corkbased sheets and metal foils such as magnetic foils. The latter is useful, when the composite material is used to cover up metal surfaces of refrigerators or heaters. The substrate may have a basis weight of from 150 to 3000 gsm or from 150 to 600 gsm and/or a substrate thickness of between 0.1 and 4,0 mm. The substrate thickness can be between 25% and 300% of the laminate structure thickness, for example between 40% and 200% or for example between 50% and 150% of the laminate structure thickness. For example, the laminate structure thickness and the substrate thickness can be within 50% of each other, or within 25% of each other, or within 10% of each other.

The flexibility of the composite material can be quantified. In an embodiment where each of the plurality of slots has an opening and at least two opposing side walls, the composite material can be such that, at the opening of at least one of the plurality of slots, the two opposing side walls can affect a relative angular displacement of at least 30°, preferably at least 60°, most preferably at least 90°.

A further aspect of the present invention pertains to a method for manufacturing a composite material, the composite material comprising a laminate structure and a substrate. Preferably, the substrate is a flexible substrate. The laminate structure having an upper surface and a lower surface, the laminate structure comprising at least one paper layer and a resin, for example at least one resin-impregnated paper. The method comprises the steps of:
i) composing the laminate structure
ii) bonding the laminate structure to the substrate, and
iii) forming a plurality of slots extending from the upper surface of the laminate structure towards the substrate.

These steps can be performed separately, for example consecutively. It is also possible that some steps, or all the steps, are performed simultaneously. For example, step i) and step ii) can be done in one pressing operation, wherein in this pressing operation a stack comprising said at least one paper layer and the flexible structure is formed, or a stack comprising multiple layers of the laminate structure-if more layers are present for said laminate structure-and the substrate is formed, after which the stack is pressed.

With this method, a composite material according to the invention can be obtained. All the advantages and preferred embodiments of said composite material therefore also apply mutatis mutandis to this method.

In an embodiment, the laminate structure has a laminate structure thickness and, preferably, the step of forming a plurality of slots comprises providing at least 50%, preferably at least 70% and more preferably all, of the slots of the plurality of slots to a depth corresponding to at least 70% of the laminate structure thickness, preferably at least 90% of the laminate structure thickness, more preferably at least 99% of the laminate structure thickness, most preferably 100% of the laminate structure thickness.

The plurality of slots forms a total slot surface area at the upper surface of the laminate structure. With at least 50% or at least 70% of the slots of the plurality of slots, is indicated that for at least 50% or at least 70% of said total slot surface area, said corresponding slots have a maximum depth as described above.

In an embodiment, the laminate structure comprises a décor layer in the form of a printed paper layer impregnated with a first resin, and at least one additional layer, the at least one additional layer being an overlay on an upper surface of the décor layer and/or a core layer on a lower surface of said décor layer.

It is not excluded that the laminate structure can comprise an untreated/unimpregnated paper layer, such as a printed paper layer, wherein this paper layer is sandwiched between two impregnated paper layers. For example the laminate structure can have one unimpregnated décor layer sandwiched between two resin impregnated overlays or sandwiched between one resin impregnated overlay and one resin impregnated kraft paper.

The plurality of slots may be formed using a laser, preferably a CO₂ laser, by milling or in a pressing operation. If said plurality of slots are formed by a pressing operation, said pressing operation can be a pressing operation which is performed after the laminate structure is bonded to the substrate. However, it is also possible that the step of bonding the laminate structure to the substrate, and the step of forming a plurality of slots, takes place in the same pressing operation. However, it is also possible that the step of creating the laminate structure (for example the HPL/CPL), the step of bonding the laminate structure to the substrate and the step of forming a plurality of slots, takes place in the same pressing operation. For this, a structured pressing element, such as a structured pressing plate, can be used. For the latter it is possible that steps i), ii) and iii) are performed in the same pressing operation or that firstly step i) is performed and said laminate structure is formed separately, after which steps ii) and iii) are performed in the same pressing operation. If said plurality of slots is formed using a laser or by milling, then the step of forming these slots is preferably performed after the laminate structure is bonded to the substrate. The bonding of said laminate structure can here take place with the aid of a pressing element. With the aid of a laser, the plurality of slots can be applied in a precise manner.

In an embodiment, the bonding step comprises providing the substrate and/or the laminate structure with an adhesive layer. The bonding step may include the application of heat and/or pressure. The bonding step may be performed in a continuous or in a short cycle press. For example, a stack comprising the substrate, the adhesive layer and the laminate structure can be formed and this stack can be pressed. Said adhesive layer can comprise a resin, with or without a paper layer. For example, said adhesive layer can be a glue layer which does not comprise a paper layer or said adhesive layer can be a resin impregnated paper. In this embodiment it is possible that the laminate structure is formed in a separate step before said stack is formed. Here the different layers of the laminate structure are laminated in a separate step and then this laminate structure is attached to said substrate with the aid of said adhesive layer. It is also possible that the laminate structure and the composite material are formed in the same pressing step. Here for example a stack is formed comprising the substrate, the adhesive layer—being for example a glue layer in liquid or powdered form—and the different layers that will form the laminate structure, wherein said stack is then pressed. As indicated above, said adhesive layer can be applied in powder form, in a (semi-)liquid state, for example a partially cured state or an uncured state, or as a resin impregnated paper. Of course, this does not exclude other ways to apply this adhesive layer.

In an embodiment, the laminate structure comprises one or more resin impregnated papers and the bonding step comprises forming a stacking comprising the substrate and the one or more resin impregnated papers and then pressing said stack. The resin of the resin impregnated paper, which lies against the substrate, will provide the bonding between the substrate and the laminate structure, which is formed during this pressing.

The method may include a further step of:
iv) at least partially filling the plurality of slots with a lacquer.

Additionally, the step of:
iv) at least partially filling said plurality of slots with a lacquer, may comprise completely filling the plurality of slots with the lacquer such that the lacquer forms an upper surface of the composite material.

The step of at least partially filing the plurality of slots with a lacquer can be done for example by spraying or jetting or roller coating—with for example soft rollers—or kiss coating or gravure coating or screen printing or impregnation. Spraying or jetting or roller coating is preferred.

Filling the plurality of slots with a lacquer can be done at company level, and this after the bonding of the laminate structure to the flexible structure and the formation of the plurality of slots, such that the composite material that is delivered to the end client already comprises the lacquer. When the laminate structure is bonded to the flexible structure and the plurality of slots are formed, but before the filling up of the slots with a lacquer, an intermediate product is created. During said filling up at company level, said intermediate product can be on a flat working surface, however it is also possible to attach said intermediate product to another product and then to fill up the slots with lacquers, to form an end product. If said another product does not have a flat surface, this is advantageous since it is then ensured that the composite material closely follows the shape of said another product. Preferably said lacquer is a resilient material, such as a PU based material, acrylic based material or an elastomer, such as latex. Alternatively, said lacquer can be a thermoset lacquer, therefore a non-flexible lacquer, to fix the composite material in the desired shape.

Another possibility is that the filling of said slots is performed at the end client and an intermediate product, being the product comprising said plurality of slots and with the laminate structure being bonded to the flexible structure, is delivered to the end client. For example, said intermediate product could be used to cover a product with a non-flat surface, after which the lacquer is applied to fill up the slots. This ensures that the product with the non-flat surface is well covered. Preferably said lacquer is a resilient material, such as a PU based material, acrylic based material or an elastomer, such as latex. Alternatively, said lacquer can be a thermoset lacquer, therefore a non-flexible lacquer, to fix the composite material in the desired shape.

A further aspect of the present invention pertains to a decorative panel. The decorative panel comprises a carrier substrate and the composite material described above.

The carrier substrate may be made from a material selected from the group consisting of wood-based boards—such as MDF (medium density fiberboard)/HDF (high density fiberboard), particle board and plywood—, mineral based board, geopolymer based boards and plastic based boards such as PVC based board and polypropylene based boards or rubber and/or elastomeric boards. Mineral based boards can be for example MgO (magnesiumoxide) based boards, cement boards or limestone based boards or gypsum based boards. Because of said substrate of the composite material, said decorative panel can have a soft feeling, for example when walked upon and/or when touched. For example, if the decorative panel is a floor panel, said decorative panel can have the feeling of a rug, though the abrasion resistance and strength of a laminate floor panel.

Said composite material can be connected to the carrier substrate by an additional adhesive layer. Said adhesive layer can comprise a thermoset, such as an aminoplast polymer produced for example by a polycondensation reaction with urea and formaldehyde, such as urea formaldehyde (UF), melamine urea formaldehyde (MUF) or melamine urea phenol formaldehyde (MUPF). The adhesive layer can for example comprise a bio-based glue, such as a glue based upon lignin and/or starch and/or sugar. The adhesive layer can comprise a PMDI based glue (polymeric methylene difenyl di-isocyanate), a polyurethane based glue, a polyvinylbutyral based glue, a polyacrylate based glue, PUR hotmelt glue, pressure sensitive glue, contact glue etc. Further, said adhesive layer can or cannot comprise a sheet, such as a paper. For example, the adhesive layer can be a resin impregnated paper. It's also not excluded that the step of adding the carrier substrate takes place in the same pressing operation, that creates the laminate structure and bonds the laminate structure to the substrate and optionally also forms the plurality of slots.

The carrier substrate can be provided with mechanical coupling parts enabling adjacent decorative panels to be coupled together.

This invention also concerns a method to form such a decorative panel comprising the step of bonding said composite material to said carrier substrate.

In the following, various non-limiting aspects of the present invention will be described in greater detail by way of example only and with reference to the attached drawings, in which:

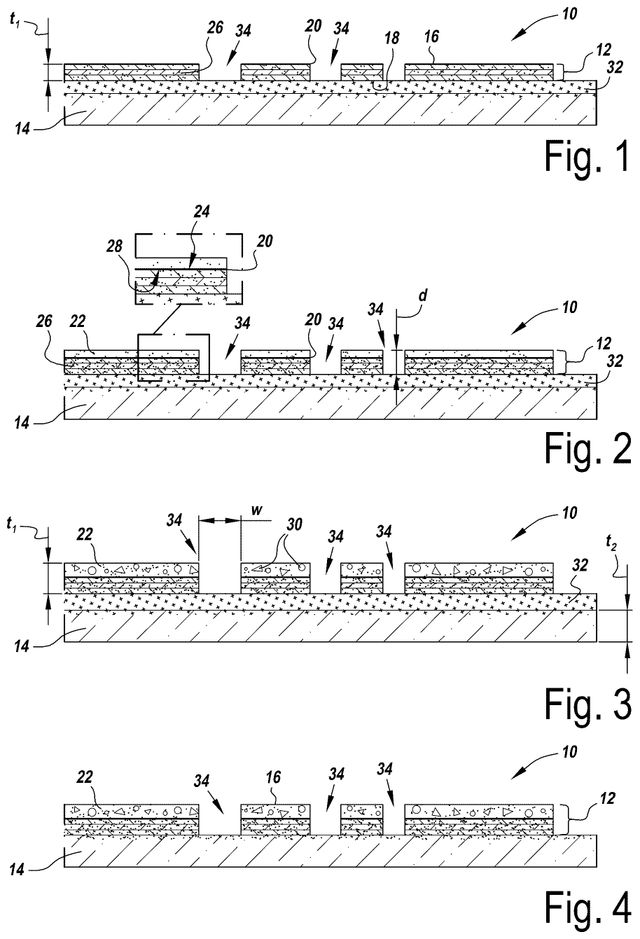

FIGS. 1 to 4 schematically illustrate various embodiments of the composite material of the present invention, seen in cross-section;

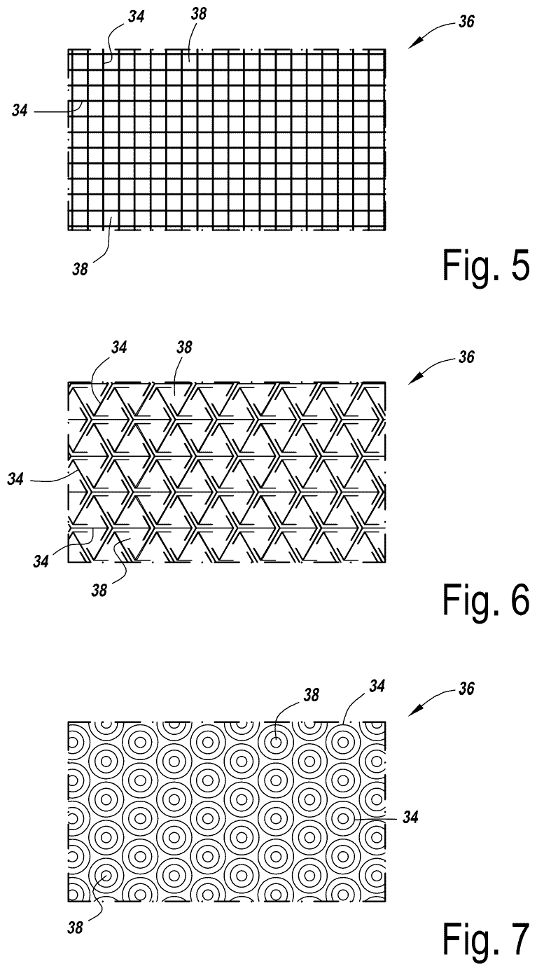

FIGS. 5 to 7 schematically illustrate various grid-structures attainable with the composite material of the present invention;

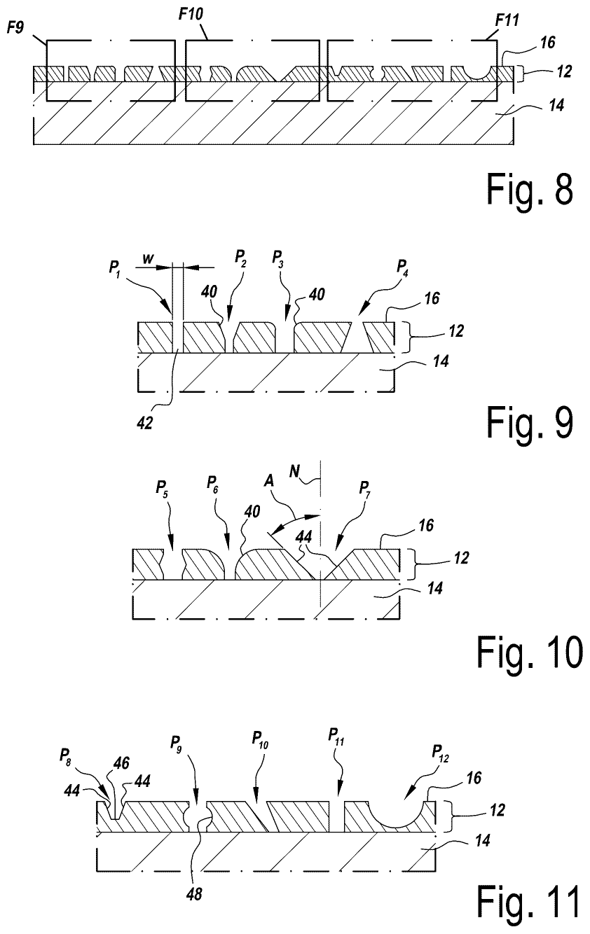

FIGS. 8 to 11 schematically illustrate possible slot profiles for use with the present invention;

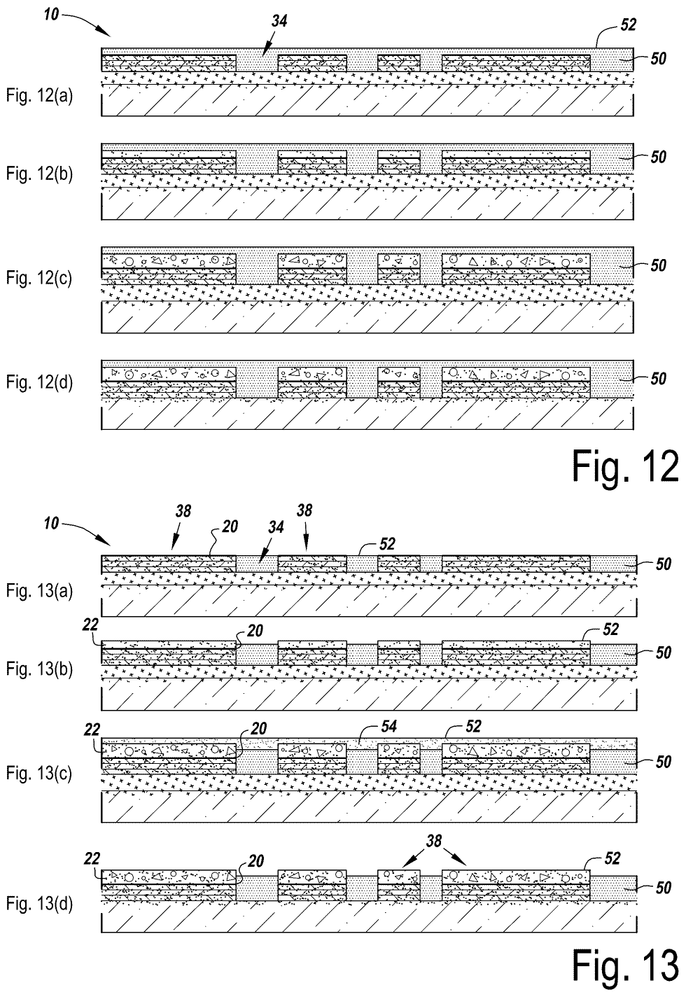

FIGS. 12 and 13 schematically illustrate various embodiments of the composite material of the present invention, seen in cross-section;

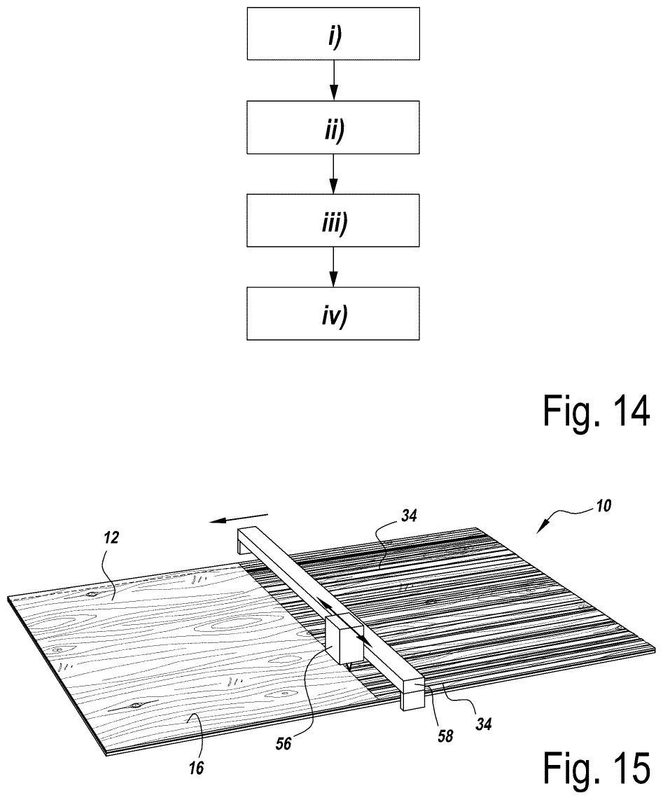

FIG. 14 is a block diagram of a method for manufacturing a composite material according to the invention;

FIG. 15 is a schematic perspective view of apparatus for forming a plurality of slots when manufacturing a composite material according to the present invention;

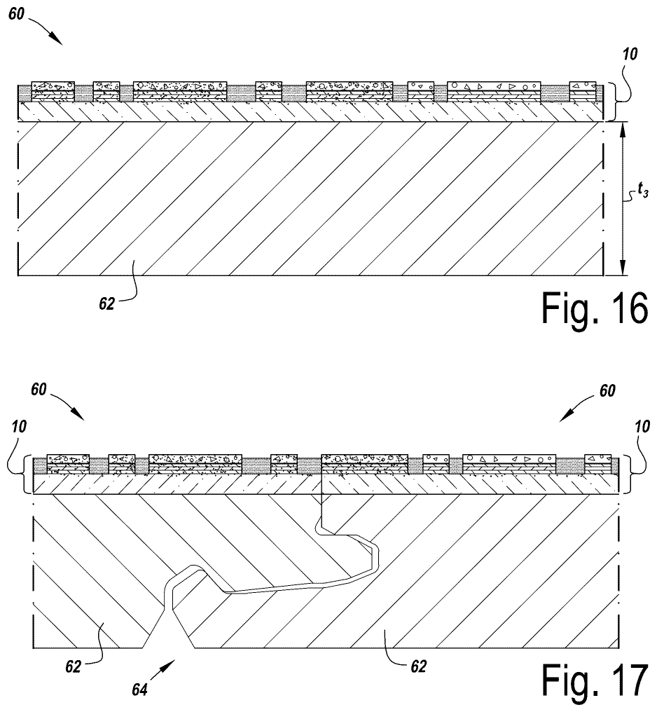

FIG. 16 schematically illustrates a decorative panel according to the present invention, seen in cross-section, and

FIG. 17 is a schematic cross-sectional view of two decorative panels according to the present invention coupled together using mechanical locking means.

In the drawings, reference number 10 denotes a composite material in accordance with the present disclosure. With reference to FIG. 1, the composite material 10 comprises a laminate structure 12 and a substrate 14. The laminate structure has an upper surface 16 and a lower surface 18 and a laminate structure thickness t₁. The laminate structure 12 comprises at least one paper and a resin. For example, the paper and the resin can be in the form of a resin impregnated paper. In the illustrated embodiments, the resin-impregnated paper is a décor layer 20 in the form of a printed paper layer impregnated with a first resin. The laminate structure 12 may comprise at least one additional layer.

As is illustrated in FIG. 2, the at least one additional layer may be constituted by an overlay 22 on an upper surface 24 of the décor layer 20 and/or one or more core layers 26 on a lower surface 28 of the décor layer. In FIG. 2, the laminate structure 12 includes both an overlay 22 and three core layers 26.

The laminate structure 12 may be a so-called HPL (High Pressure Laminate) or a CPL (Continuous Pressed Laminate). Both laminates consist of cellulose fiber sheets, preferably papers, impregnated with thermosetting resins. CPL is preferably produced in continuous double belt presses with a pressure between 30 and 70 bar and temperatures between 140° C. and 190° C., or using press rollers. HPL can be produced in a discontinuous press. When the resin cures, a substantially rigid laminate structure is attained.

By way of example, the paper layer forming the décor layer 20 may be constituted by a 50-160 g/m² printed paper impregnated with a similar amount of resin. One example is a 70 g/m² printed paper impregnated with about 70 g/m² of a thermosetting resin such as UF, MUF or MF. The decor layer may be a pigmented paper layer of any desirable colour. For example the paper layer can be incorporated with colorants. The décor layer may be printed with any image, such as a wood print, a stone print, a carbon-fibre image, a fancy pattern or a logo with or without text. The image may be printed using any known printing technique, such as digital printing, rotogravure, etc. Due to its boundless flexibility, digital printing using computer-controlled ink jet printers is preferred.

The overlay 22 is provided when increased wear/scratch resistance of the laminate structure 12 is desired. The overlay 22 generally comprises a paper layer impregnated with a thermosetting resin which is compatible with, preferably identical to, the resin used in the decor layer 20. To ensure transparency after curing, the paper layer should be thin, for example about 25 g/m², and consist essentially entirely of pure alpha-cellulose. The amount of resin may be about 3 times the basis weight of the paper. Thus, for a paper layer of 25 g/m², the amount of resin may be about 75 g/m². To improve abrasion resistance, and as is illustrated in FIG. 3, the overlay 22 may include hard particles 30 such as corundum or aluminium oxide.

Each core layer 26 may be a resin impregnated kraft paper, for example sodium kraft paper. Typically, the kraft paper may have a basis weight of 70-300 g/m². The resin amount may be between 70 and 300 g/m².

Depending i.a. on the intended application and the number of paper layers, the laminate structure 12 may have a thickness t₁ of between 0.20 mm and 4.0 mm, preferably between 0.5 mm and 2.5 mm.

In accordance with one aspect of the present invention, the laminate structure 12 is bonded to the substrate 14. The choice of material for the substrate will depend on the intended use of the composite material, and may include woven or nonwoven webs, textile cloths, foamed sheets (preferably a flexible foamed sheet) and extruded films. The substrate 14 may have a basis weight of from 150 to 3000 g/m² and/or a substrate thickness t₂ of between 0.10 and 3.0 mm. In one embodiment, the substrate thickness t₂ may be between 25% and 300% of the laminate structure thickness t₁.

Bonding of the laminate structure 12 to the substrate may be attained by means of an adhesive layer 32. Alternatively, and as is illustrated in FIG. 4, the laminated structure 12 may be directly bonded to the substrate 14. As will be described below, when the laminate structure and flexible laminate are directly bonded to each other, adhesion between the laminate structure 12 and the substrate 14 is attained by means of some of the resin in the laminate structure 12 partially impregnating the substrate 14 and, upon curing of the resin, hardening. Although in FIG. 4 the composite material 10 is depicted as having a laminate structure 12 with an overlay 22, it is to be understood that direct bonding of the laminate structure 12 to the substrate 14 can be attained with any previously described laminate structures 12.

To render the composite material 10 flexible, the laminate structure 12 includes a plurality of slots 34 extending from the upper surface 16 of the laminate structure 12 towards the substrate 14. The plurality of slots 34 may have a depth d corresponding to at least 70% of the laminate structure thickness t₁, preferably at least 90% of the laminate structure thickness t₁. In some embodiments, the plurality of slots 34 extends through at least 99% of the laminate structure thickness t₁ or, as illustrated in the drawings, through the entire thickness of the laminate structure 12. The plurality of slots 34 may extend over the entire upper surface 16 of the laminate structure 12 or only in selected regions in which flexibility of the composite material 10 is desired.

As is depicted in FIGS. 5 to 7, the plurality of slots 34 may form a grid structure 36 made up of intersecting rows of the plurality of slots 34. Consequently, the laminate structure 12 is divided into laminate structure islands 38. The shape of the islands 38 will depend on the course of the intersecting rows, but they may for example be square, oblong, triangular, polygonal or rhomboid. These shapes can be attained when the plurality of slots 34 is rectilinear. In non-illustrated alternative embodiments, at least some of the plurality of slots 34 may be non-rectilinear, for example having the shape of a sine wave. In FIG. 7, the laminate structure islands 36 are essentially circular. It is to be understood that the composite material 10 may comprise regions of different shapes of laminate structure islands 38.

The degree of flexibility of the composite material 10 will, at least in part, be dictated by the dimensions of the plurality of slots 34 and the distribution density of the slots. In various embodiments, the plurality of slots 34 may have a slot width w at the upper surface 16 of the laminate structure 12 which is at least 5% of the laminate structure thickness t₁, preferably at least 10%, more preferably at least 20% and most preferably at least 30% of the laminate structure thickness t₁. The actual widths of the slots making up the plurality of slots 34 may vary. Irrespective of any variation in the width of the slots 34, the laminate structure islands 38 combine to provide a laminate structure surface area The grid structure 38 made up of the laminate structure islands 38 and the plurality of slots 34 extends over a grid structure surface area. The ratio of laminate structure surface area to grid structure surface area may lie between 30% and 95%.

With particular reference to FIGS. 8 to 11, each slot of the plurality of slots 34 may have an essentially constant slot width w throughout the depth d of the slot. Alternatively, some or all slots of the plurality of slots 34 may have a width which varies from the upper surface 16 of the laminate structure 12 towards the substrate 14. Thus, each slot has a cross-sectional profile P and a grid structure 36 may include a plurality of slots 34 having the same or a number of different cross-sectional profiles. FIG. 8 depicts a cross-section through a theoretical grid structure made up of slots of differing profiles P₁ to P₁₂. The profiles are shown in greater detail in FIGS. 9 to 11. With reference to FIG. 9, a first slot may have a cross-sectional profile P₁ in which the width w of the slot is constant from the upper surface 16 of the laminate structure 12 to the substrate 14. A second slot may have a profile P₂ that has an opening 40 which is tapered or bevelled and which transitions into a lower slot portion 42 with parallel, vertically disposed side walls. The profile denoted P₃ is similar to that of P₂ except that the opening 40 is rounded. The profile P₄ has a slot width w that increases constantly from the opening 40 to the substrate 14 to thereby form a slot having a frustoconical profile. Turning now to FIG. 10, a fifth slot may have a profile P₅ in which the slot width increases from the upper surface 16 of the laminate structure to a maximum value and then decreases towards the substrate 14.

The profile denoted P₆ is similar to that of P₃ except that the opening 40 is more rounded. The profile P₇ has a “V” or truncated V-shape. In this embodiment, the slot has opposing side walls 44, each of which subtends an angle A from a normal N to the upper surface 16 of between 5° and 60°, preferably up to 45°. With reference to FIG. 11, the profile denoted P₈ is in the form of a trough with inclined opposing side walls 44 and a base 46. The profile denoted P₉ is essentially rectangular, though with the opposing side walls having concave portions 48 along their respective lengths. The profile denoted P₁₀ is in the form of an oblique slot tapering inwardly towards the substrate. The profile denoted P₁₁ has a rectangular shape whereas the profile denoted P₁₂ is rounded and the slot is accommodated within the laminate structure 12. Although the profile P₁₂ is illustrated as having the shape of a semi-circle, it is to be understood that any suitably curved profile may be adopted.

In accordance with a further aspect of the present invention, the plurality of slots 34 may be at least partially filled with a lacquer 50. In the examples a) to d) illustrated in FIG. 12 the lacquer 50 completely fills the plurality of slots 34 and forms an upper surface 52 of the composite material 10. It will be recognised that example a) utilizes the composite material of FIG. 1, example b) utilizes the composite material of FIG. 2, example c) utilizes the composite material of FIG. 3 and example d) utilizes the composite material of FIG. 4.

In a similar vein, FIG. 13 illustrates various examples of a composite material comprising a laminate structure with a plurality of slots which are at least partially filled with lacquer. By way of example, example a) illustrates the composite material of FIG. 1, with the lacquer 50 completely filling the plurality of slots such that the upper surface 52 of the resulting composite material 10 is constituted in part by the décor layer 20 of the laminate structure islands 38 and in part by the lacquer 50 in the plurality of slots 34. It is to be understood that any of the FIGS. 1 to 4 embodiments of composite material 10 may utilise lacquer in the manner illustrated in example a) of FIG. 13. In example b) of FIG. 13, the composite material 10 of FIG. 2 is utilized, with the lacquer 50 filling the plurality of slots 34 to a level slightly below the upper surface 52 of the resulting composite material 10, though slightly above the décor layer 20. Consequently, the upper surface 52 of the resulting composite material 10 is constituted in part by the overlay 22 of the laminate structure islands 38 and in part by the lacquer 50 in the plurality of slots 34. Again, it is to be understood that any of the FIGS. 1 to 4 embodiments of composite material 10 may utilise lacquer in the manner illustrated in example b) of FIG. 13. In example c) of FIG. 13, the composite material 10 of example b) of FIG. 13 is utilized, though with an additional lacquer layer 54 forming the upper surface 52 of the resulting composite material. In example d) of FIG. 13, the composite material 10 of FIG. 4 is utilized, with the lacquer 50 filling the plurality of slots 34 to a level slightly below the upper surface 52 of the resulting composite material, though slightly above the décor layer 20. Consequently, the upper surface 52 of the resulting composite material 10 is constituted in part by the overlay 22 of the laminate structure islands 38 and in part by the lacquer 50 in the plurality of slots 34. Common to examples a), b) and d) of FIG. 13 is that the only elements of the composite material 10 that are exposed to possible wear are the laminate structure 12 and the lacquer 50. Furthermore, optical properties of the lacquer may be balanced to those of the laminate structure islands 38 to give a desirable aesthetic appearance.

The lacquer itself, as well as the additional lacquer layer 54, may be water-based and/or curable (such as curable by thermal energy or UV/LED radiation). The specific composition of the lacquer will influence the flexible properties of the composite material and may be chosen to impart a desired degree of flexibility. Typically, the lacquer will be PU-based, acrylic-based or latex. It is not inconceivable that the lacquer may be in the form of a thermosetting plastic. To impart a desired visual effect, the lacquer may by transparent, translucent and/or coloured. The lacquer may comprise additives selected from the group consisting of anti-abrasive particles such as corundum, matting agents, easy-cleaning additives, and anti-slip additives.

An advantage offered by an embodiment having an additional lacquer layer 54, such as example c) of FIG. 13, is that additives may be included only in the additional lacquer layer, thereby reducing the amount of additives that would otherwise be needed.

A further aspect of the present invention relates to a method for manufacturing a composite material of the type described above in relation to FIGS. 1 to 13. To recap, such composite material 10 comprises a laminate structure 12 and a substrate 14. The laminate structure 12 has an upper surface 16 and a lower surface 18. The laminate structure 12 comprises at least one paper layer and a resin, for example at least one resin-impregnated paper. With reference to FIG. 14, the method for manufacturing the composite material comprises the steps of:
i) composing the laminate structure 12;
ii) bonding the laminate structure 12 to the substrate 14, and
iii) forming a plurality of slots 34 extending from the upper surface 16 of the laminate structure 12 towards the substrate 14.

The step i) of composing the laminate structure includes compiling the various paper layers, e.g. one or more core layers 26, the décor layer 20 and/or the overlay, together with possibly an additional resin. In embodiments in which the laminate structure is an HPL (High Pressure Laminate) or a CPL (Continuous Pressed Laminate), the constituent paper layers are each impregnated with resin or some paper layers are impregnated with resin, and are brought into overlying relationship with each other and united under heat and pressure such that the resin cures to create a substantially rigid laminate structure 12. The step ii) of bonding the laminate structure to the substrate 14 may then be attained by providing the substrate and/or the laminate structure with an adhesive layer 32.

In an alternative embodiment, the step of composing the laminate structure includes bringing the constituent paper layers into overlying relationship not only with each other but also with the substrate to form a stack. The stack is then subjected to heat and pressure, for example in a continuous press or in a short-cycle press, to thereby directly bond the laminate structure to the substrate. The resulting composite material may be termed a DPL (Direct Pressure Laminate).

Irrespective of how the laminate structure 12 is bonded to the substrate 14, a plurality of slots 34 is formed in the laminate structure. In accordance with step iii) of the method according to the invention, the plurality of slots 34 extends from the upper surface 16 of the laminate structure 12 towards the substrate 14. In one embodiment of the method according to the present invention, the plurality of slots 34 may be formed simultaneously with the bonding of the laminate structure to the substrate. This can be attained by providing the press with a press plate having projections corresponding to the plurality of slots. Alternatively, the plurality of slots may be formed once the laminate structure has been bonded to the substrate. The plurality of slots may be formed in a milling operation, or using a laser, for example a CO₂ laser.

A method for forming the plurality of slots 34 is depicted in FIG. 15. In this drawing, the upper surface 16 of the laminate structure 12 is being treated using a laser 56 mounted for displacement along a cross-beam 58. The laser 56 generates a beam which removes material from the laminate structure 12. As a result of relative displacement between the laser 56 and the laminate structure, a plurality of slots 34 is produced. Displacement of the laminate structure 12 with respect to the cross-beam 58, the laser 56 along the cross-beam and deflection of the laser beam are advantageously computer-controlled to thereby create a desired grid structure 36 and slot profile P, examples of which have been described above in relation to FIGS. 5 to 7 and 8 to 11, respectively. It is to be understood that neither the grid structure nor the slot profile needs be uniform over the entire upper surface 16 of the laminate structure. Instead, there may be regions on the upper surface having different grid structures and/or different slot profiles. There may also be regions having no grid structure. In this manner, the composite material 10 may have regions of differing flexibility.

The laminate structure 12 of FIG. 15 is shown purely by way of example as having a décor layer printed with a wood-grain pattern. In addition to the plurality of slots 34, the upper surface 16 of the laminate structure 12 may also be provided with (not shown) embossments in register with the wood-grain pattern. These embossments may be provided prior to the formation of the plurality of slots, for example by providing protrusions on a press plate used in the forming of the laminate structure. Alternatively, the embossments may be created by a laser before, during or after the formation of the plurality of slots.

With reference to FIG. 14, the method according to the invention may include a further step iv) of at least partially filling the plurality of slots 34 with a lacquer 50. This method may result in embodiments of the composite material 10 as illustrated by way of example in FIG. 13. In a further embodiment, the step iv) of at least partially filling the plurality of slots 34 with a lacquer 50 may include completely filling the plurality of slots such that the lacquer forms an upper surface 52 of the composite material 10. Utilizing this step may result in embodiments of the composite material 10 as illustrated by way of examples in FIG. 12. Step iv) may include partially filling the plurality of slots with a first lacquer 50 and then completely filling the slots with an additional lacquer 54, as shown in example c) of FIG. 13.

In a further aspect of the invention, the composite material 10 described above may be used in a decorative panel 60. Thus, and with reference to FIGS. 16 and 17, a decorative panel 60 according to the present invention comprises a carrier substrate 62 and a composite material 10. Examples of possible composite materials are described above in relation to FIGS. 1 to 13. Examples of suitable materials for the carrier substrate 62 include wood-based boards such as MDF/HDF, particle board and plywood, mineral based board, and resilient plastics such as PVC and polypropylene, elastomeric boards, such as EPDM, rubber or TPU (thermoplastic polyurethane). The composite material may be bonded to the carrier substrate 62 using any known techniques such as by means of a (not shown) adhesive layer between the composite material 10 and the carrier substrate 62. The carrier substrate can be bonded to the flexible & laminate structure during a pressing step.

The carrier substrate has a thickness t₃. The thickness will depend i.a. on the intended use of the decorative panel 60 and may lie between 1.0 mm and 20.0 mm, preferably between 3.0 mm and 15.0 mm. The carrier substrate thickness t₃ may be sufficient to allow the carrier substrate 62 to be provided with mechanical coupling parts 64 enabling adjacent decorative panels 60 to be coupled together. In FIG. 17, mechanical coupling parts 64 are illustrated in the form of a milled tongue-and-groove connection, for example of the type described in WO-A-97/47834. However, it is to be understood that the carrier substrate 62 may be provided with mechanical coupling parts 64 of the fold-down or push-down type and preferably of the type that undergoes a snap-action during joining.

In a particular embodiment, the decorative panel 60 may include a composite material 10 that has a substrate 14 of a foamed material. This provides a cushioning effect for any load placed on the decorative panel. This may be advantageous when the decorative panel is used in a floor covering.

The composite material of the present invention may be used for any applications in which flexibility of the composite material is desirable. For example, the composite material may exhibit drapeability, thereby mimicking a fabric. This allows the composite material to be used in applications such as clothing, footwear, home furnishings, upholstery, interior surfaces for vehicles, luggage, flooring-for example as an alternative to a carpet-, covering of metal surfaces—for example surfaces of refrigerators or heaters—, etc.

Here below three specific examples are discussed:

### EXAMPLE 1

The built up (from top to bottom) is the following:
Impregnated overlay paper with a thermoset melamine formaldehyde resin: alpha-cellulose paper 20 gsm, impregnated with resin towards 100 gsm, including 15 gsm corundum (particle size of corundum: 50-80 micron)
non-impregnated decor paper: digitally printed 70 gsm paper
impregnated overlay paper with a thermoset melamine formaldehyde resin: alpha-cellulose paper 20 gsm, impregnated with resin towards 100 gsm
Impregnated kraft papers (with a MF/PF mixture): 2 sheets of 160 gsm kraft paper each treated with resin towards 280 gsm
between 50 and 200 gsm glue application
microfiber textile backing (1 mm thickness, 500 gsm, being a mixture of PU and PA)

In this example firstly a HPL is created comprising said papers resulting in a thickness of between 650 and 800 μm, as such creating the laminate structure. Then this HPL is glued to said microfiber textile backing (said substrate) resulting in a thickness of between 1,65 and 1,8 mm. Then a pattern is lasered with the aid of a CO₂ laser throughout the entire thickness of the HPL, the pattern comprising squares.

### EXAMPLE 2

In this example the use of melamine resin is avoided to reduce the hardness, resulting in easier lasercutting (and also less toxic fumes/emissions/dust during lasercutting) and a more flexible end product.

The built up (from top to bottom) is the following:
Impregnated overlay paper with a waterbased polyurethane dispersion resin: alpha-cellulose paper 20 gsm, impregnated with resin towards 100 gsm, including small micro particles to enhance scratch resistance (corundum platelets of between 5 and 15 micron)
impregnated decor paper: digitally printed 70 gsm paper, with a PU dispersion towards 130 gsm.
Impregnated kraft papers (with a PU dispersion): 2 sheets of 160 gsm kraft paper each treated with resin towards 280 gsm
between 50 and 200 gsm glue application
microfiber textile backing (1 mm thickness, 500 gsm, being a mixture of PU and PA)

In this example firstly a HPL is created comprising said papers resulting in a thickness of between 650 and 800 μm, as such creating the laminate structure. Then this HPL is glued to said microfiber textile backing (said substrate) resulting in a thickness of between 1,65 and 1,8 mm. Then a pattern is lasered with the aid of a CO₂ laser throughout the entire thickness of the HPL, the pattern comprising squares.

### EXAMPLE 3

In this example an acrylic resin is used and the pattern (the grid structure) is created by pressing. No additional laser and/or cutting step is needed.

The built up (from top to bottom) is the following:
impregnated decor paper: digitally printed 70 gsm paper, with an acrylic thermoset coating
impregnated kraft papers (with a PU/acrylic dispersion): 2 sheets of 160 gsm kraft paper each treated with resin towards 280 gsm
between 50 and 200 gsm glue application
rubber matt (3 mm thickness, density of 700 kg/m³, shore hardness 40 A)

These layers are pressed in one pressing operation, wherein an embossed pressing plate is used on top. The pressing conditions can be 180° C., pressure of 80 kg/cm² and this during 30 seconds. The rubber matt is here the substrate, the said papers form the laminate structure and the said glue connects the laminate structure to the substrate. The embossed pressing plate forms the slots during the pressing operation, as such forming the composite material in one pressing operation.

According to a deviating variant, the invention concerns a composite material comprising a laminate structure, as mentioned above, slots as mentioned above—which do or do not go through the entire thickness of the laminate structure—and optionally a lacquer as mentioned above, wherein this composite material does not comprise said substrate, such that said deviating variant only comprises a laminate structure, slots and optionally a lacquer.

The invention also concerns two other deviating variants being a method to produce the abovementioned deviating composite material and a decorative panel comprising a carrier substrate and said deviating composite material. The additional features of the first mentioned composite material, method and decorative panel are also combinable with the above-mentioned deviating variants, according to all non-contradictory combinations. With the aid of said deviating composite material, shine-trough effects/see through effects can be created, better acoustic properties can be obtained, a breathable structure can be created.

The invention has been described above by way of non-limiting embodiments and examples. The skilled person will understand that the invention may be varied within the scope of the appended claims.

1.-32. (Cancelled).

33. A composite material comprising a laminate structure and a substrate, said laminate structure having an upper surface and a lower surface, said laminate structure comprising at least one paper and a resin, said laminate structure being bonded to said substrate, said laminate structure including a plurality of slots extending from said upper surface of said laminate structure towards said substrate.

34. The composite material according to claim 33, wherein the laminate structure has a laminate structure thickness and wherein at least 50% of the slots of said plurality of slots have a depth corresponding to at least 70% of the laminate structure thickness.

35. The composite material according to claim 33, wherein the laminate structure comprises a décor layer in the form of a printed and/or colored paper layer impregnated with a first resin, and at least one additional layer, said at least one additional layer being an overlay on an upper surface of said décor layer and/or a core layer on a lower surface of said décor layer.

36. The composite material according to claim 33, wherein the laminate structure comprises a décor layer in the form of a printed paper layer which is not impregnated, and at least two additional layers, which two additional layers are resin impregnated papers with the décor layer sandwiched between said two additional layers, and with said at least one additional layer being a resin impregnated overlay on an upper surface of said décor layer and/or a resin impregnated core layer on a lower surface of said décor layer.

37. The composite material according to claim 34, wherein said laminate structure thickness is between 0.2 and 4.0 mm.

38. The composite material according to claim 33, wherein said laminate structure is bonded to said substrate by means of an adhesive layer.

39. The composite material according to claim 33, wherein said laminated structure is directly bonded to said substrate.

40. The composite material according to claim 33, wherein said plurality of slots forms a pattern comprising intersecting slots,.

41. The composite material according to claim 40, wherein the grid structure is made up of laminate structure islands and said plurality of slots,
wherein the laminate structure islands combine to provide a laminate structure surface area,
wherein the laminate structure islands and the plurality of slots extends over a grid structure surface area,
wherein the ratio of laminate structure surface area to grid structure surface area lies between 30% and 95%.

42. The composite material according to claim 33, wherein said plurality of slots is rectilinear.

43. The composite material according to claim 33, wherein said plurality of slots has a slot width at said upper surface of said laminate structure, said slot width being at least 5% of said laminate structure thickness.

44. The composite material according to claim 33, wherein said plurality of slots is at least partially filled with a lacquer.

45. The composite material according to claim 44, wherein said lacquer is PU-based, acrylic-based or latex, the lacquer being transparent and/or colored.

46. The composite material according to claim 44, wherein the lacquer comprises additives selected from the group consisting of anti-abrasive particles including corundum, matting agents, easy-cleaning additives, and anti-slip additives.

47. The composite material according to claim 44, wherein the laminate structure comprises a décor layer in the form of a printed and/or colored paper layer impregnated with a first resin, and at least one additional layer, said at least one additional layer being an overlay on an upper surface of said décor layer and/or a core layer on a lower surface of said décor layer,
wherein said additional layer is said overlay and said lacquer fills said plurality of slots up to said overlay such that said overlay is exposed.

48. The composite material according to claim 44, wherein said lacquer completely fills said plurality of slots and forms an upper surface of said composite material.

49. The composite material according to claim 33, wherein said substrate is selected from the group consisting of woven or nonwoven webs, textile cloths, foamed sheets, thermoplastic films, elastomeric sheets, rubber sheets and metal foils.

50. The composite material according to claim 49, wherein said substrate has a basis weight of from 150 to 600 gsm and/or a substrate thickness of between 0.1 and 3.0 mm.

51. The composite material according to claim 33, wherein said substrate has a substrate thickness of between 25% and 300% of the laminate structure thickness.

52. The composite material of claim 33, wherein the substrate is a flexible substrate.
